(19) United States
(12) Patent Application Publication
(10) Pub. No.: US 2025/0294544 A1
(43) Pub. Date: Sep. 18, 2025

(54) PAGING TRIGGERED SEMI-PERSISTENT SCHEDULING RESOURCE ACTIVATION FOR MOBILE TERMINATED SMALL DATA TRANSMISSION

(71) Applicant: QUALCOMM Incorporated, San Diego, CA (US)

(72) Inventors: Ruiming ZHENG, Beijing (CN); Chao WEI, Beijing (CN); Jing DAI, Beijing (CN); Ozcan OZTURK, San Diego, CA (US)

(21) Appl. No.: 18/861,357

(22) PCT Filed: Jun. 29, 2022
(86) PCT No.: PCT/CN2022/102162

§ 371 Date: Oct. 29, 2024

(51) Int. Cl. H04W 72/11; H04B 7/06; H04W 68/02; H04W 72/23; H04W 76/27

(52) U.S. Cl. CPC H04W 72/11; H04B 7/0626; H04W 68/02; H04W 72/23; H04W 76/27

(57) ABSTRACT

Various aspects of the present disclosure generally relate to wireless communication. In some aspects, a user equipment (UE) may receive, from a network node, a configuration of a semi-persistent scheduling (SPS) resource for downlink data reception in an inactive state. The UE may receive, from the network node and while operating in the inactive state, paging downlink control information (DCI) and a paging message for triggering downlink data reception in the inactive state, wherein the paging DCI or the paging message includes an indication that activates the SPS resource for downlink data reception in the inactive state. The UE may receive, from the network node and while operating in the inactive state, one or more transmissions of downlink data via the SPS resource for downlink data reception in the inactive state. Numerous other aspects are described.

### FIELD OF THE DISCLOSURE

Aspects of the present disclosure generally relate to wireless communication and to techniques and apparatuses for paging triggered semi-persistent scheduling (SPS) resource activation for mobile terminated small data transmission (MT-SDT).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive, from a network node, a configuration of a semi-persistent scheduling (SPS) resource for downlink data reception in an inactive state. The one or more processors may be configured to receive, from the network node and while operating in the inactive state, paging downlink control information (DCI) and a paging message for triggering downlink data reception in the inactive state, wherein the paging DCI or the paging message includes an indication that activates the SPS resource for downlink data reception in the inactive state. The one or more processors may be configured to receive, from the network node and while operating in the inactive state, one or more transmissions of downlink data via the SPS resource for downlink data reception in the inactive state.

Some aspects described herein relate to a network node for wireless communication. The network node may include a memory and one or more processors coupled to the memory. The one or more processors may be configured to transmit, to a UE, a configuration of an SPS resource for downlink data reception in an inactive state. The one or more processors may be configured to transmit, to the UE while the UE is in the inactive state, paging DCI and a paging message for triggering downlink data reception in the inactive state, wherein the paging DCI or the paging message includes an indication that activates the SPS resource for downlink data reception in the inactive state. The one or more processors may be configured to transmit, to the UE while the UE is in the inactive state, one or more transmissions of downlink data via the SPS resource for downlink data reception in the inactive state.

Some aspects described herein relate to a method of wireless communication performed by a UE. The method may include receiving, from a network node, a configuration of an SPS resource for downlink data reception in an inactive state. The method may include receiving, from the network node and while operating in the inactive state, paging DCI and a paging message for triggering downlink data reception in the inactive state, wherein the paging DCI or the paging message includes an indication that activates the SPS resource for downlink data reception in the inactive state. The method may include receiving, from the network node and while operating in the inactive state, one or more transmissions of downlink data via the SPS resource for downlink data reception in the inactive state.

Some aspects described herein relate to a method of wireless communication performed by a network node. The method may include transmitting, to a UE, a configuration of an SPS resource for downlink data reception in an inactive state. The method may include transmitting, to the UE while the UE is in the inactive state, paging DCI and a paging message for triggering downlink data reception in the inactive state, wherein the paging DCI or the paging message includes an indication that activates the SPS resource for downlink data reception in the inactive state. The method may include transmitting, to the UE while the UE is in the inactive state, one or more transmissions of downlink data via the SPS resource for downlink data reception in the inactive state.

Some aspects described herein relate to a non-transitory computer-readable medium that stores a set of instructions for wireless communication by a UE. The set of instructions, when executed by one or more processors of the UE, may cause the UE to receive, from a network node, a configuration of an SPS resource for downlink data reception in an inactive state. The set of instructions, when executed by one or more processors of the UE, may cause the UE to receive, from the network node and while operating in the inactive state, paging DCI and a paging message for triggering downlink data reception in the inactive state, wherein the paging DCI or the paging message includes an indication that activates the SPS resource for downlink data reception in the inactive state. The set of instructions, when executed by one or more processors of the UE, may cause the UE to receive, from the network node and while operating in the inactive state, one or more transmissions of downlink data via the SPS resource for downlink data reception in the inactive state.

Some aspects described herein relate to a non-transitory computer-readable medium that stores a set of instructions for wireless communication by a network node. The set of instructions, when executed by one or more processors of the network node, may cause the network node to transmit, to a UE, a configuration of an SPS resource for downlink data reception in an inactive state. The set of instructions, when executed by one or more processors of the network node, may cause the network node to transmit, to the UE while the UE is in the inactive state, paging DCI and a paging message for triggering downlink data reception in the inactive state, wherein the paging DCI or the paging message includes an indication that activates the SPS resource for downlink data reception in the inactive state. The set of instructions, when executed by one or more processors of the network node, may cause the network node to transmit, to the UE while the UE is in the inactive state, one or more transmissions of downlink data via the SPS resource for downlink data reception in the inactive state.

Some aspects described herein relate to an apparatus for wireless communication. The apparatus may include means for receiving, from a network node, a configuration of an SPS resource for downlink data reception in an inactive state. The apparatus may include means for receiving, from the network node and while operating in the inactive state, paging DCI and a paging message for triggering downlink data reception in the inactive state, wherein the paging DCI or the paging message includes an indication that activates the SPS resource for downlink data reception in the inactive state. The apparatus may include means for receiving, from the network node and while operating in the inactive state, one or more transmissions of downlink data via the SPS resource for downlink data reception in the inactive state.

Some aspects described herein relate to an apparatus for wireless communication. The apparatus may include means for transmitting, to a UE, a configuration of an SPS resource for downlink data reception in an inactive state. The apparatus may include means for transmitting, to the UE while the UE is in the inactive state, paging DCI and a paging message for triggering downlink data reception in the inactive state, wherein the paging DCI or the paging message includes an indication that activates the SPS resource for downlink data reception in the inactive state. The apparatus may include means for transmitting, to the UE while the UE is in the inactive state, one or more transmissions of downlink data via the SPS resource for downlink data reception in the inactive state.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a mobile originated (MO) random access (RA) small data transmission (SDT), in accordance with the present disclosure.

FIG. 5 is a diagram illustrating an example of an MO configured grant (CG) SDT, in accordance with the present disclosure.

FIG. 6 is a diagram illustrating an example of a mobile transmitted (MT) RA SDT, in accordance with the present disclosure.

FIG. 7 is a diagram illustrating an example of downlink semi-persistent scheduling (SPS) communications, in accordance with the present disclosure.

FIG. 8 is a diagram illustrating an example associated with paging triggered SPS resource activation for MT-SDT, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

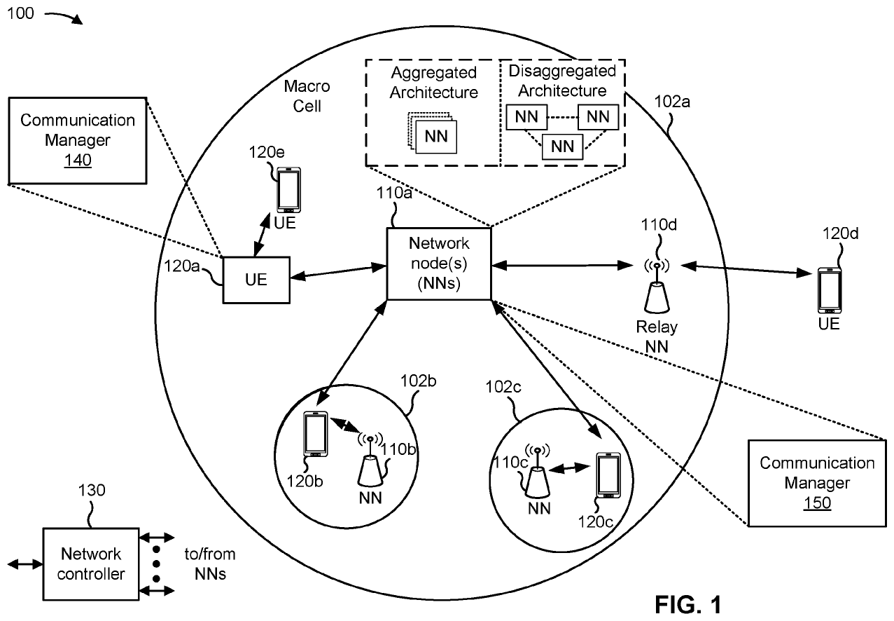

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, a configuration of a semi-persistent scheduling (SPS) resource for downlink data reception in an inactive state; receive, from the network node and while operating in the inactive state, paging downlink control information (DCI) and a paging message for triggering downlink data reception in the inactive state, wherein the paging DCI or the paging message includes an indication that activates the SPS resource for downlink data reception in the inactive state; and receive, from the network node and while operating in the inactive state, one or more transmissions of downlink data via the SPS resource for downlink data reception in the inactive state. Additionally, or alternatively, the communication manager 140 may perform one or more other operations described herein.

In some aspects, the network node 110 may include a communication manager 150. As described in more detail elsewhere herein, the communication manager 150 may transmit, to a UE, a configuration of an SPS resource for downlink data reception in an inactive state; transmit, to the UE while the UE is in the inactive state, paging DCI and a paging message for triggering downlink data reception in the inactive state, wherein the paging DCI or the paging message includes an indication that activates the SPS resource for downlink data reception in the inactive state; and transmit, to the UE while the UE is in the inactive state, one or more transmissions of downlink data via the SPS resource for downlink data reception in the inactive state. Additionally, or alternatively, the communication manager 150 may perform one or more other operations described herein.

As indicated above, FIG. 1 is provided as an example. Other examples may differ from what is described with regard to FIG. 1.

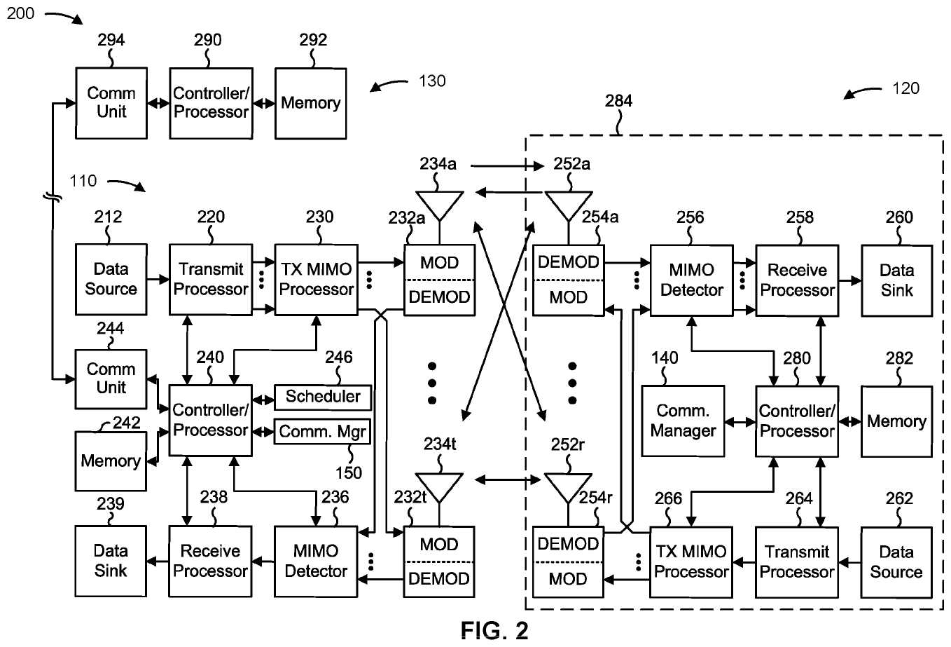

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

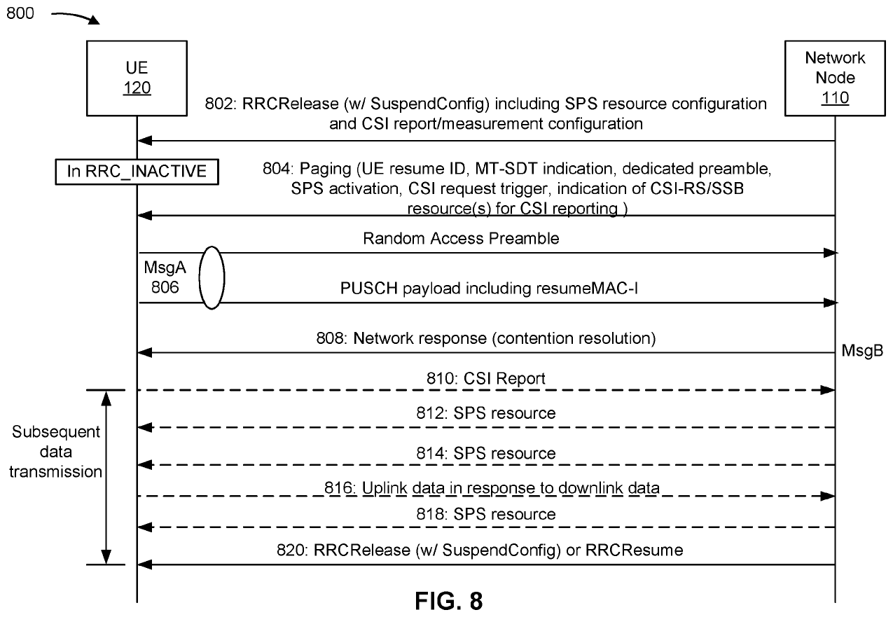

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-12).

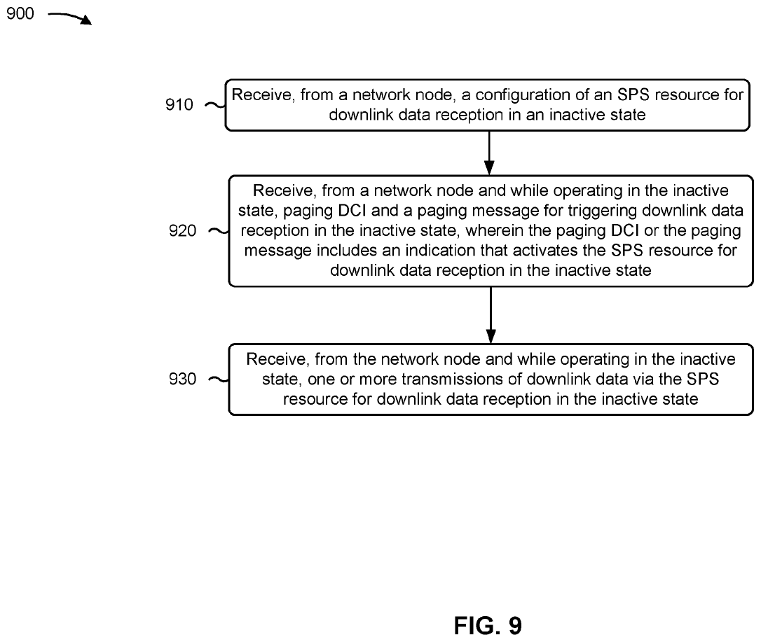

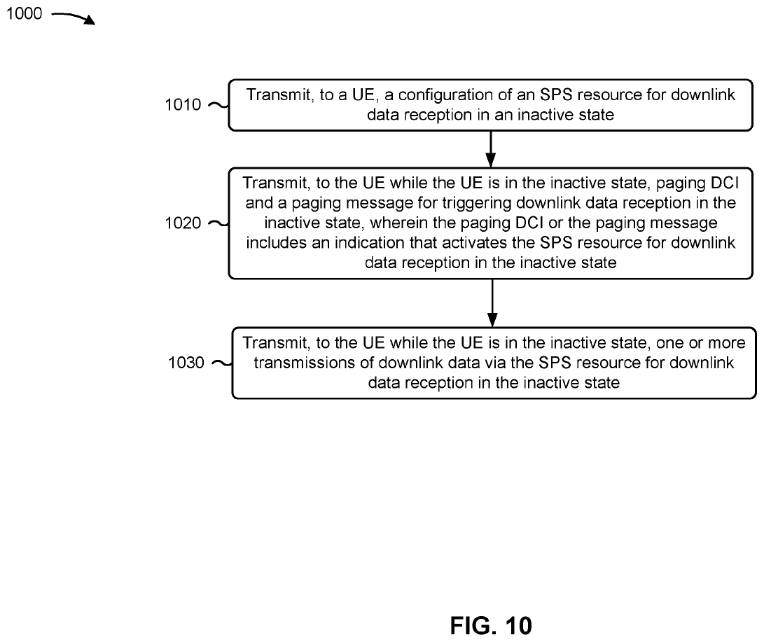

The controller/processor 240 of the network node 110, the controller/processor 280 of the UE 120, and/or any other component(s) of FIG. 2 may perform one or more techniques associated with paging triggered SPS resource activation for mobile terminated small data transmission (MT-SDT), as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving, from a network node, a configuration of an SPS resource for downlink data reception in an inactive state; means for receiving, from the network node and while operating in the inactive state, paging DCI and a paging message for triggering downlink data reception in the inactive state, wherein the paging DCI or the paging message includes an indication that activates the SPS resource for downlink data reception in the inactive state; and/or means for receiving, from the network node and while operating in the inactive state, one or more transmissions of downlink data via the SPS resource for downlink data reception in the inactive state. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting, to a UE, a configuration of an SPS resource for downlink data reception in an inactive state; means for transmitting, to the UE while the UE is in the inactive state, paging DCI and a paging message for triggering downlink data reception in the inactive state, wherein the paging DCI or the paging message includes an indication that activates the SPS resource for downlink data reception in the inactive state; and/or means for transmitting, to the UE while the UE is in the inactive state, one or more transmissions of downlink data via the SPS resource for downlink data reception in the inactive state. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an JAB network, an open radio access network (O-RAN (such as the network configuration sponsored by the O-RAN Alliance)), or a virtualized radio access network (vRAN), also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

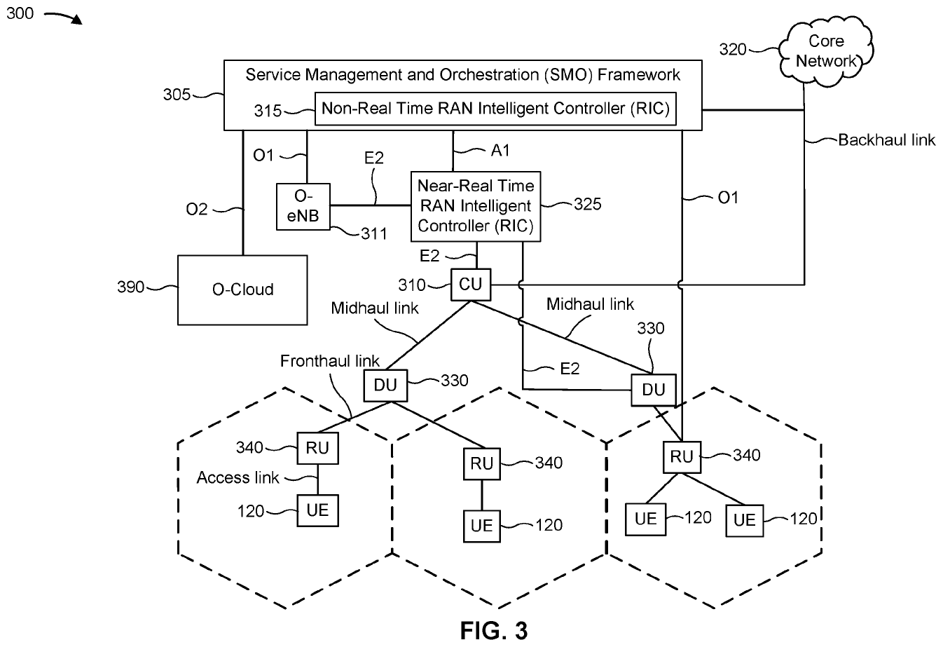

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

Small data transmission (SDT) refers to data transmission, from or to a UE, while the UE is an inactive state (e.g., a radio resource control (RRC) inactive state). In a mobile originated (MO) SDT (MO-SDT) framework, a network node may allow a UE to transmit uplink small data (e.g., an amount of uplink data that is less than a configured threshold) in an RRC inactive/idle mode, without the UE having to move to an RRC connected mode. A random access channel (RACH) based MO-SDT procedure may involve uplink SDTs for RACH-based schemes (e.g., two-step RACH or four-step RACH) from the RRC inactive state. A configured grant (CG) based MO-SDT procedure may involve a transmission of uplink data on preconfigured physical uplink shared channel (PUSCH) resources (e.g., reusing a CG type 1). In some aspects, subsequent transmissions of small data in an uplink direction and in a downlink direction may be supported.

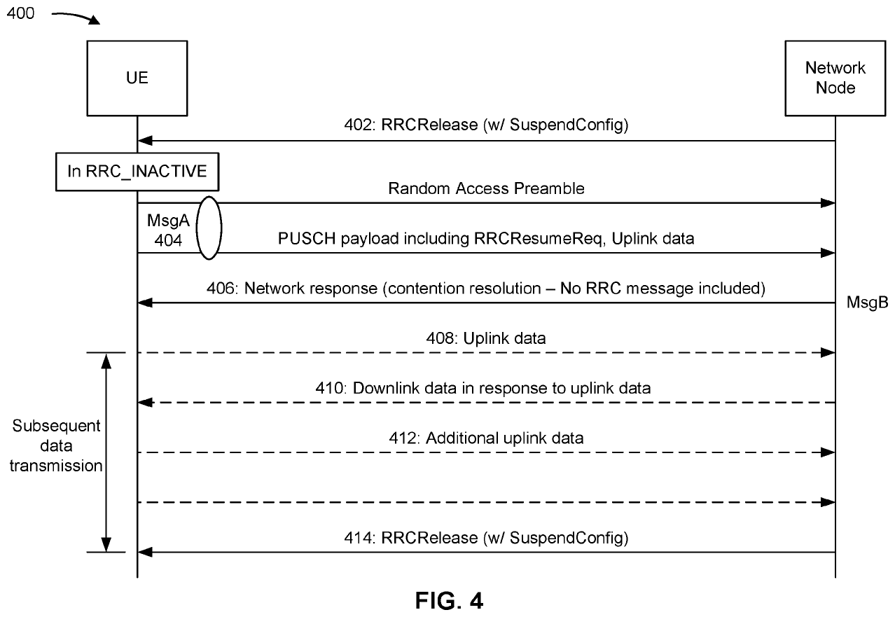

FIG. 4 is a diagram illustrating an example 400 of an MO-random access (RA)-SDT, in accordance with the present disclosure. As shown in FIG. 4, communication may occur between a UE (e.g., UE 120) and a network node (e.g., network node 110). In some aspects, the UE and the network node may be included in a wireless network, such as wireless network 100.

As shown by reference number 402, as part of MO-RA-SDT based at least in part on a two-step RACH, the UE may receive, from the network node, an RRC release message that indicates a suspend configuration, and the UE may enter an RRC inactive/idle mode. As shown by reference number 404, the UE may transmit, to the network node, a random access preamble and a PUSCH payload including an RRC resume request and uplink data, which may be part of a MsgA. As shown by reference number 406, the UE may receive, from the network node, a network response that indicates a contention resolution, which may be part of a MsgB, where the network response may not include an RRC message. At this point, subsequent data transmissions may occur between the UE and the network node. As shown by reference number 408, the UE may transmit uplink data to the network node. As shown by reference number 410, the UE may receive, from the network node, downlink data in response to the uplink data. As shown by reference number 412, the UE may transmit additional uplink data to the network node. As shown by reference number 414, the UE may receive, from the network node, an RRC release message that indicates a suspend configuration.

As indicated above, FIG. 4 is provided as an example. Other examples may differ from what is described with regard to FIG. 4.

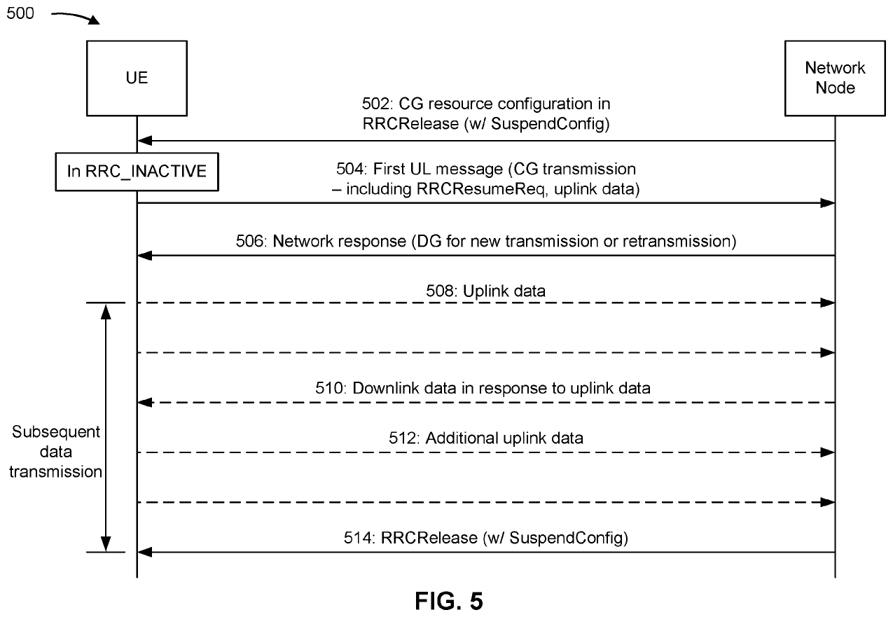

FIG. 5 is a diagram illustrating an example 500 of an MO-CG-SDT, in accordance with the present disclosure. As shown in FIG. 5, communication may occur between a UE (e.g., UE 120) and a network node (e.g., network node 110). In some aspects, the UE and the network node may be included in a wireless network, such as wireless network 100.

As shown by reference number 502, as part of the MO-CG-SDT, the UE may receive, from the network node, a CG resource configuration in an RRC release message that indicates a suspend configuration, and the UE may enter an RRC inactive/idle mode. The CG resource configuration may indicate a configured PUSCH resource for MO-SDT. As shown by reference number 504, the UE may transmit, to the network node, a first uplink message, which may be a CG transmission (e.g., a transmission on the configured PUSCH resource) that indicates an RRC resume request and uplink data. As shown by reference number 506, the UE may receive, from the network node, a network response, which may indicate a dynamic grant (DG) for a new uplink transmission or a retransmission of the uplink data included in the first uplink message. At this point, subsequent data transmissions may occur between the UE and the network node. As shown by reference number 508, the UE may transmit uplink data to the network node. As shown by reference number 510, the UE may receive, from the network node, downlink data in response to the uplink data. As shown by reference number 512, the UE may transmit additional uplink data to the network node. As shown by reference number 514, the UE may receive, from the network node, an RRC release message that indicates a suspend configuration.

As indicated above, FIG. 5 is provided as an example. Other examples may differ from what is described with regard to FIG. 5.

MT-SDT may be downlink data initiated SDT. For example, MT-SDT for a UE may be initiated when a small amount of downlink data (e.g., less than a configured threshold) is ready to be transmitted from a network node to the UE. In some aspects, MT-SDT may be triggered by paging a UE. An MT-SDT procedure, for a UE, may involve an initial downlink data reception and subsequent uplink/downlink data transmissions in an RRC inactive/idle state. In some examples, an MO-RA-SDT procedure and/or an MO-CG-SDT procedure may be reused for transmission, by a UE, of an uplink response to the downlink data received in the MT-SDT procedure.

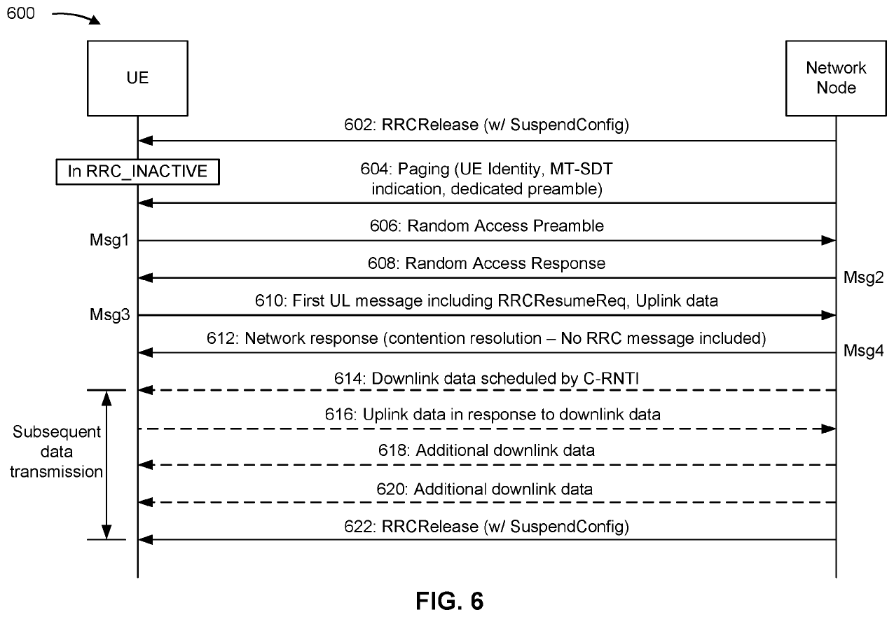

FIG. 6 is a diagram illustrating an example 600 of an MT-RA-SDT, in accordance with the present disclosure. As shown in FIG. 6, communication may occur between a UE (e.g., UE 120) and a network node (e.g., network node 110). In some aspects, the UE and the network node may be included in a wireless network, such as wireless network 100.

As shown by reference number 602, as part of an MT-RA-SDT based at least in part on a four-step RACH, the UE may receive, from the network node, an RRC release message that indicates a suspend configuration, and the UE may enter an RRC inactive/idle mode. As shown by reference number 604, the UE may receive, from the network node, a paging message, which may indicate a UE identity, an MT-SDT indication, and a dedicated preamble. As shown by reference number 606, the UE may transmit, to the network node, a random access preamble (Msg1). For example, the UE may transmit, to the network node, the dedicated preamble indicated in the paging message. As shown by reference number 608, the UE may receive, from the network node, a random access response (Msg2). As shown by reference number 610, the UE may transmit, to the network node, a first uplink message that indicates an RRC resume request and uplink data (Msg3). As shown by reference number 612, the UE may receive, from the network node, a network response that indicates a contention resolution (Msg4), where the network response may not include an RRC message. As shown by reference number 614, the UE may receive, from the network node, downlink data scheduled by a physical downlink control channel (PDCCH) communication associated with a cell radio network temporary identifier (C-RNTI). At this point, subsequent data transmissions may occur between the UE and the network node. As shown by reference number 616, the UE may transmit, to the network node, uplink data in response to the downlink data scheduled by the C-RNTI. As shown by reference numbers 618 and 620, the UE may receive, from the network node, additional downlink data. In this case, each additional transmission of downlink data may be scheduled by a respective PDCCH communication (e.g., a PDCCH communication associated with the C-RNTI). As shown by reference number 622, the UE may receive, from the network node, an RRC release message that indicates a suspend configuration.

As indicated above, FIG. 6 is provided as an example. Other examples may differ from what is described with regard to FIG. 6.

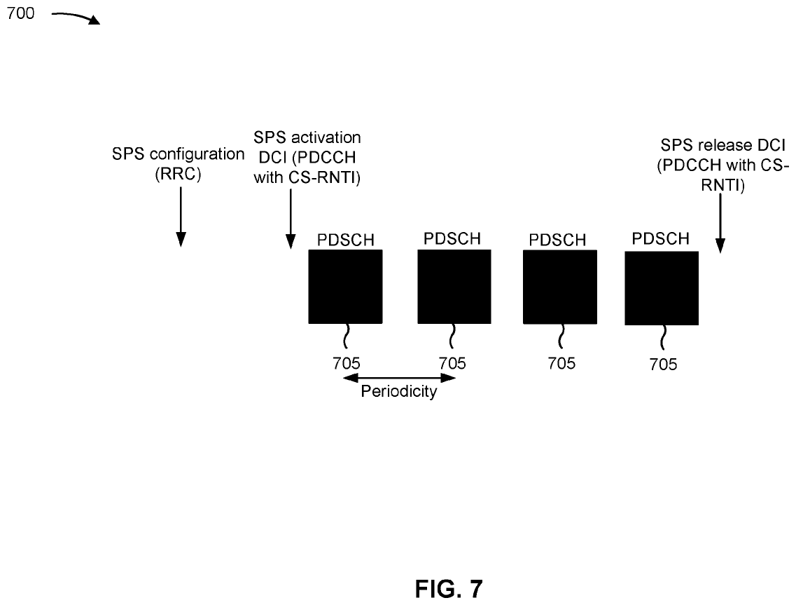

FIG. 7 is a diagram illustrating an example 700 of downlink SPS communications, in accordance with the present disclosure. SPS communications may include periodic downlink communications that are configured for a UE, such that a network node does not need to transmit (e.g., directly or via one or more network nodes) separate DCI to schedule each downlink communication, thereby conserving signaling overhead.

As shown in FIG. 7, a UE may be configured with an SPS configuration for SPS communications. For example, the UE may receive the SPS configuration via an RRC message transmitted by a network node (e.g., directly or via one or more network nodes). The SPS configuration may indicate a periodicity at which an allocated downlink resource is repeated for the downlink SPS. The SPS configuration may also indicate a number of configured hybrid automatic repeat request (HARQ) processes for the downlink SPS and a physical uplink control channel (PUCCH) resource for the UE to transmit HARQ feedback for the downlink SPS.

The UE, while operating in an RRC connected state, may monitor a PDCCH addressed to CS-RNTI (e.g., a PDCCH with a cyclic redundancy check (CRC) scrambled by CS-RNTI). In some examples, a downlink resource assignment, for downlink SPS, may be indicated via a PDCCH communication (e.g., a PDCCH communication addressed to a CS-RNTI), and the UE may store the downlink resource assignment based at least in part on layer 1 (L1) signaling indicating SPS activation. As shown in FIG. 7, the network node may transmit, to the UE in a PDCCH communication addressed to a CS-RNTI, SPS activation DCI to activate the SPS configuration for the UE. In some examples, the SPS activation DCI may indicate an assignment of an allocated downlink resource (e.g., a physical downlink shared channel (PDSCH) resource). In this case, the allocated downlink resource may be repeated at the periodicity indicated in the SPS configuration, resulting in periodically reoccurring scheduled SPS occasions 705 for the UE. For example, the network node may assign the allocated downlink resource for an initial SPS downlink communication (e.g., an initial HARQ transmission) to the UE. The UE may begin monitoring the SPS occasions 705 based at least in part on receiving the SPS activation DCI. The UE may monitor the allocated downlink resource (e.g., the PDSCH resource) at each SPS occasion 705.

In some examples, the UE may clear the downlink resource assignment for the downlink SPS based at least in part on L1 signaling indicating SPS deactivation. As shown in FIG. 7, the network node may transmit, to the UE in a PDCCH communication addressed to a CS-RNTI, SPS release DCI to deactivate the SPS configuration for the UE. The UE may stop monitoring the scheduled SPS occasions 705 based at least in part on receiving the SPS release DCI. When the SPS is released by upper layers, the UE may release all corresponding SPS configurations.

As indicated above, FIG. 7 is provided as an example. Other examples may differ from what is described with respect to FIG. 7.

As described above in connection with FIG. 6, MT-SDTs (e.g., transmissions of small amounts of downlink data) to a UE may be scheduled by respective PDCCH dynamic grants. However, in a case in which MT-SDTs are scheduled for a large number of UEs (e.g., a large number of IoT devices), scheduling transmissions of small amounts of downlink data using PDCCH dynamic grants may be inefficient due to the large downlink signaling overhead associated with the PDCCH dynamic grants. In some aspects, using SPS to schedule periodically occurring downlink resources for transmitting MT-SDTs to UEs may reduce the downlink signaling overhead as compared with scheduling MT-SDTs by PDCCH dynamic grants. However, there is currently no mechanism for downlink SPS activation and resource assignment for a UE operating in an RRC inactive state.

Some techniques and apparatuses described herein enable paging triggered SPS resource activation for downlink reception by a UE in an inactive state. The UE may receive, from a network node, a configuration of an SPS resource for downlink data reception in the inactive state. The UE may receive, from a network node and while the UE is operating in the inactive state, paging DCI and a paging message for triggering downlink data reception in the inactive state. The paging DCI or the paging message may include an indication that activates the SPS resource for downlink data reception in the inactive state. The UE may receive, from the network node and while the UE is operating in the inactive state, one or more transmissions of downlink data via the SPS resource for downlink data reception in the inactive state. As a result, a periodically occurring SPS resource may be used for transmissions of downlink data to a UE while the UE is in the inactive state (e.g., for MT-SDTs), which reduces downlink signaling overhead as compared to scheduling MT-SDTs using PDCCH dynamic grants. Such reduced downlink signaling overhead may improve network efficiency and decrease UE power consumption, due to reduced PDCCH decoding.

Some techniques and apparatuses described herein enable the paging message, for triggering downlink data reception for the UE in the inactive mode, to trigger downlink channel state information (CSI) reporting for the downlink data reception in the inactive state (e.g., for MT-SDT). In some aspects, the paging DCI or the paging message may include an indication for triggering downlink CSI reporting for downlink data reception in the inactive state, and the UE may transmit a CSI report to the network node while operating in the inactive state based at least in part on the indication for triggering downlink CSI reporting for downlink data reception in the inactive state. In some aspects, the network node may determine an MCS and/or other transmission parameters for the transmissions of downlink data to the UE via the SPS resource based at least in part on the downlink CSI reporting, which may result in improved quality and reliability for the transmissions of downlink data to the UE while the UE is in the inactive state (e.g., for MT-SDT).

FIG. 8 is a diagram illustrating an example 800 associated with paging triggered SPS resource activation for MT-SDT, in accordance with the present disclosure. As shown in FIG. 8, example 800 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As shown in FIG. 8, and by reference number 802, the network node 110 may transmit, to the UE 120, an RRC release message (e.g., RRCRelease) that includes a suspend configuration (e.g., SuspendConfig). The UE 120 may receive, from the network node 110, the RRC release message that includes the suspend configuration. The UE 120 may receive the RRC release message while operating in an RRC connected state. The UE 120, in connection with receiving the RRC release message that includes the suspend configuration, may switch from the RRC connected state to an RRC inactive state. The suspend configuration may indicate parameters associated with operations of the UE 120 while in the RRC inactive state. For example, the suspend configuration may indicate a paging cycle for the UE 120 in the RRC inactive state.

In some aspects, the network node 110 may transmit, and the UE 120 may receive, an SPS resource configuration for MT-SDT for the UE 120. For example, the SPS resource configuration for MT-SDT may be a configuration of an SPS resource for downlink data reception in an inactive state (e.g., in the RRC inactive state). The UE 120 may receive the SPS resource configuration for MT-SDT from the network node 110 while the UE 120 is in the RRC connected state. In some aspects, the UE 120 may receive the SPS resource configuration for MT-SDT via system information. For example, the network node 110 may transmit, to the UE 120, system information including an indication of the SPS resource configuration for MT-SDT. In some aspects, the network node 110 may receive the SPS resource configuration for MT-SDT via dedicated RRC signaling from the network node 110. In some aspects, as shown in FIG. 8, the SPS resource configuration for MT-SDT (e.g., the configuration of the SPS resource for downlink data reception in the RRC inactive state) may be included in the RRC release message. For example, the RRC release message may include dedicated RRC signaling that indicates the SPS resource configuration for MT-SDT for the UE 120.

In some aspects, the SPS resource configuration for MT-SDT (e.g., the configuration of the SPS resource for downlink data reception in the RRC inactive state) may include an SPS configuration and an indication of an SPS PDSCH resource to be used, in accordance with the SPS configuration, for downlink data reception in the RRC inactive state when the SPS resource configuration is activated. The SPS configuration, included in the SPS resource configuration, may indicate a periodicity at which the SPS resource (e.g., the SPS PDSCH resource indicated in the SPS resource configuration) is repeated for downlink data reception in the RRC inactive state. The SPS configuration, included in the SPS resource configuration, may also indicate a number of HARQ processes for the downlink SPS in the RRC inactive state and a PUCCH resource for transmitting HARQ feedback for downlink communications received via the downlink SPS in the RRC inactive state. In some aspects, when the SPS resource configuration for MT-SDT is activated, the configured SPS PDSCH resource, indicated in the SPS resource configuration for MT-SDT, may be repeated in periodically reoccurring SPS occasions during MT-SDT in accordance with the SPS configuration indicated in the SPS resource configuration for MT-SDT.

In some aspects, whether the network node 110 configures the SPS resource configuration for MT-SDT for the UE 120 may be based at least in part on a reported UE capability of the UE 120. For example, the UE 120 may transmit, to the network node 110 (e.g., while in the RRC connected state), a UE capability report that includes an indication of whether the UE 120 supports SPS PDSCH reception for SDT. In this case, the network node 110 may transmit the SPS resource configuration for MT-SDT to the UE 120 (e.g., in the RRC release message or in the system information) based at least in part on the UE capability report indicating that the UE 120 supports SPS PDSCH reception for SDT. In some aspects, one or multiple SPS resource configurations for MT-SDT may be configured for the UE 120. For example, the network node 110 RRC release message may indicate one or multiple SPS resource configurations for MT-SDT (e.g., configurations of one or more SPS resources for downlink data reception in the RRC inactive state). In some aspects, the UE 120 may transmit, to the network node 110 (e.g., while in the RRC connected state), a UE capability report that indicates whether the UE 120 supports multiple SPS resource configurations for MT-SDT in a bandwidth part (BWP) and/or a quantity of SPS resource configurations for MT-SDT in a BWP supported by the UE 120. In this case, the quantity of SPS resource configurations for MT-SDT for the UE 120 (e.g., the quantity of SPS resource configurations indicated in the RRC release message) may be based at least in part on the reported capability of the UE 120 for supporting multiple SPS resource configurations for MT-SDT in a BWP.

In some aspects, a CG type-1 for SDT configuration and the SPS configuration for MT-SDT may be independently configured for the UE 120, based at least in part on respective reported UE capabilities. For example, the network node 110 may configure the SPS configuration for MT-SDT for the UE 120, but not configure a CG resource for SDT for the UE 120. In some aspects, the RRC release message may indicate the SPS configuration for MT-SDT, a configured CG resource for SDT, or both the SPS configuration for MT-SDT and the configured CG resource for SDT.

In some aspects, the one or more SPS resource configurations for MT-SDT may be indicated, in the dedicated RRC signaling, as a list of one or more downlink SPS configurations to be added or modified in one BWP (e.g., SPS-ConfigToAddModList). In some aspects, the list of the one or more SPS resource configurations for MT-SDT (e.g., SPS-ConfigToAddModList) may be included in configuration information relating to a dedicated BWP for downlink SDT (e.g., BWP-Downlink-Dedicated-SDT) that is included in a SDT configuration (e.g., SDT-Config) for the UE 120. In some aspects, the list of the one or more SPS resource configurations for MT-SDT (e.g., SPS-ConfigToAddModList) may include a sequence of SPS configurations (e.g., SPS-Config).

In some aspects, the network node 110 may transmit, and the UE 120 may receive, a CSI report configuration (e.g., CSI-ReportConfig) and/or a CSI measurement configuration (e.g., CSI-MeasConfig) for downlink CSI reporting for MT-SDT. For example, UE 120 may receive the CSI report configuration and/or the CSI measurement configuration for downlink CSI reporting for MT-SDT via dedicated RRC signaling from the network node 110, while the UE 120 is in the RRC connected state. In some aspects, as shown in FIG. 8, the CSI report configuration and/or the CSI measurement configuration for downlink CSI reporting for MT-SDT may be included the RRC release message. For example, the RRC release message may include dedicated RRC signaling that indicates the CSI report configuration and/or the CSI measurement configuration for downlink CSI reporting for MT-SDT. In some aspects, the CSI report configuration, included in the RRC release message, may indicate at least one of a dedicated PUCCH resource for periodic (or semi-persistent) CSI reporting or a PUSCH resource for aperiodic CSI reporting. In some aspects, the CSI measurement configuration, included in the RRC release message, may indicate resources associated with one or more downlink reference signals to be measured for downlink CSI reporting for MT-SDT. For example, the downlink reference signals to be measured for downlink CSI reporting may include CSI reference signals (CSI-RSs) and/or synchronization signal blocks (SSBs). In some aspects, the CSI measurement configuration, included in the RRC release message, may indicate a configuration of a resource pool (e.g., a CSI-RS/SSB resource pool) including a set of downlink reference signal resources (e.g., CSI-RS resources and/or SSB resources).

As further shown in FIG. 8, and by reference number 804, the network node 110 may page the UE 120, while the UE 120 is in the RRC inactive state, to trigger MT-SDT for the UE 120 (e.g., to trigger downlink data reception in the RRC inactive state for the UE 120). The network node 110 may transmit, to the UE 120 while the UE 120 is in the RRC inactive state, paging DCI and a paging message for triggering MT-SDT for the UE 120. For example, the paging message may indicate, to the UE 120, that downlink data for the UE 120 is ready to be transmitted to the UE 120. In some aspects, when downlink data for the UE 120 arrives in a buffer of the network node 110, the network node 110 may transmit the paging DCI and the paging message to inform the UE 120 of the downlink data to be transmitted to the UE 120 and to trigger MT-SDT (e.g., downlink data reception in the RRC inactive state) for the UE 120.

The UE 120, while in the RRC inactive state, may receive the paging DCI and the paging message transmitted by the network node 110. In some aspects, the UE 120 may monitor for paging DCI (e.g., DCI with a CRC scrambled by a paging radio network temporary identifier (P-RNTI)) in paging occasions of a paging cycle. For example, the paging cycle for the UE 120 in the RRC inactive state may be configured in the suspend configuration included in the RRC release message. The paging DCI may be included in a PDCCH communication, and the paging DCI may indicate that the paging message is transmitted in a PDSCH communication. The UE 120 may receive the paging DCI in a paging occasion, and based at least in part on receiving the paging DCI in the paging occasion, the UE 120 may receive and decode the PDSCH communication including the paging message.

In some aspects, the paging message may indicate a UE resume identifier (ID), an MT-SDT indication, and/or a dedicated random access preamble. The UE resume ID may indicate a UE ID of a UE to which the paging message applies (e.g., the UE being paged by the paging message). The MT-SDT indication may be an indication that the paging message is for triggering MT-SDT (e.g., RA-based MT-SDT or CG-based MT-SDT) for the UE identified by the UE resume ID. For example, the paging message may trigger MT-SDT for the UE 120 based at least in part on the paging message including the MT-SDT indication and the paging message indicating a UE resume ID that matches the UE ID of the UE 120. In some aspects, the paging message may be used to page multiple UEs. In this case, the paging message may indicate a set of UE resume IDs that identify a set of UEs to which the paging message applies. The dedicated random access preamble may be a random access preamble to be used by the UE 120 to initiate a RACH procedure for MT-SDT.

In some aspects, the paging DCI or the paging message may include an indication that activates the SPS resource configuration for MT-SDT. In this case, the indication, included in the paging DCI or the paging message, may activate the SPS resource, configured in the SPS resource configuration, for downlink data reception in the RRC inactive state.

In some aspects, the paging DCI (e.g., paging PDCCH) may include the indication that activates the SPS resource configuration for MT-SDT. For example, the paging DCI may include a one-bit or multiple bit indication (e.g., a “flag”) that indicates activation of the SPS resource configuration for MT-SDT. In some aspects, the paging DCI may include a one-bit indication that provides a binary indication of whether to activate the SPS resource configuration for MT-SDT. In some aspects, the paging DCI may include a multiple bit indication that indicates which SPS resource configuration for MT-SDT, of one or more SPS resource configurations for MT-SDT configured for the UE 120, is to be activated. For example, the paging DCI may include a multiple bit indication that indicates an index (e.g., SPS-configindex) associated with the SPS resource configuration for MT-SDT to be activated. In some aspects, the indication, included in the paging DCI, may activate one or more SPS resource configurations for MT-SDT.

In some aspects, when the paging DCI includes the indication that activates the SPS resource configuration for MT-SDT, the UE 120 may determine whether a UE ID indicated in the paging message (e.g., the UE resume ID) matches the UE ID of the UE 120. For example, the paging message may indicate one or more UE IDs (e.g., one or more UE resume IDs), and the UE 120 may determine whether the one or more UE IDs indicated in the paging message include the UE ID of the UE 120. If the paging DCI includes the indication that activates the SPS resource configuration for MT-SDT and the one or more UE IDs indicated in the paging message include the UE ID of the UE 120, the UE 120 may activate the configured SPS resource for downlink data reception in the inactive state (e.g., the UE 120 may proceed with monitoring the periodically reoccurring SPS resource for downlink data reception in the inactive state). If the paging DCI includes the indication that activates the SPS resource configuration for MT-SDT, but the one or more UE IDs indicated in the paging message do not include the UE ID of the UE 120, the UE 120 may ignore the indication, in the paging DCI, of activation of the SPS resource configuration for MT-SDT.

In some aspects, the paging message may include the indication that activates the SPS resource configuration for MT-SDT. For example, the paging message may include a one-bit or multiple bit indication (e.g., a “flag”) that indicates activation of the SPS resource configuration for MT-SDT. In some aspects, the paging message may include a one-bit indication that provides a binary indication of whether to activate the SPS resource configuration for MT-SDT. In some aspects, the paging message may include a multiple bit indication that indicates which SPS resource configuration for MT-SDT, of one or more SPS resource configurations for MT-SDT configured for the UE 120, is to be activated. For example, the paging message may include a multiple bit indication that indicates an index (e.g., SPS-configindex) associated with the SPS resource configuration for MT-SDT to be activated. In some aspects, the indication, included in the paging message, may activate one or more SPS resource configurations for MT-SDT.

In some aspects, when the paging message includes the indication that activates the SPS resource configuration for MT-SDT, the UE 120 may determine whether a UE ID indicated in the paging message (e.g., the UE resume ID) matches the UE ID of the UE 120. For example, the paging message may indicate one or more UE IDs (e.g., one or more UE resume IDs), and the UE 120 may determine whether the one or more UE IDs indicated in the paging message include the UE ID of the UE 120. If the paging message includes the indication that activates the SPS resource configuration for MT-SDT and the one or more UE IDs indicated in the paging message include the UE ID of the UE 120, the UE 120 may activate the configured SPS resource for downlink data reception in the inactive state (e.g., the UE 120 may proceed with monitoring the periodically reoccurring SPS resource for downlink data reception in the inactive state). If the paging message includes the indication that activates the SPS resource configuration for MT-SDT, but the one or more UE IDs indicated in the paging message do not include the UE ID of the UE 120, the UE 120 may ignore the indication, in the paging message, of activation of the SPS resource configuration for MT-SDT.

In some aspects, the paging DCI or the paging message may include an indication for triggering downlink CSI reporting for MT-SDT (e.g., downlink CSI reporting for downlink data reception in the RRC inactive state). In some aspects, the paging message may indicate one or more candidate reference signal resources (e.g., CSI-RS and/or SSB resources) for the downlink CSI reporting for MT-SDT. For example, the paging message may indicate one or more candidate reference signal resources, from the set of reference signal resources included in the resource pool configured in the CSI measurement configuration included in the RRC release message. In this way, the paging message may tailor the resource pool configured in the CSI measurement configuration to specify reference signal resources to be used for the CSI measurements for the downlink CSI reporting for MT-SDT. For example, the paging message may indicate a configured CSI-RS resource to be measured for the downlink CSI reporting for MT-SDT, or the paging message may indicate the use of an SSB for the downlink CSI reporting for MT-SDT. In some aspects, the paging message may indicate a dedicated PUCCH resource (e.g., for periodic/semi-persistent CSI reporting) and/or a PUSCH resource (e.g., for aperiodic CSI reporting). For example, the paging message may indicate the dedicated PUCCH resource and/or the PUSCH resource in a case in which the RRC release message does not indicate a configuration for the dedicated PUSCH resource and/or the PUCCH resource.

In some aspects, the indication for triggering downlink CSI reporting for MT-SDT may be included in a dedicated field (e.g., a CSI request field) in the paging DCI. In some aspects, the CSI request field, in the paging DCI, may include an indication for triggering aperiodic CSI reporting for MT-SDT. In some aspects, the CSI request field, in the paging DCI, may include an indication for triggering semi-persistent CSI reporting for MT-SDT. For example, the indication, in the CSI request field in the paging DCI, may trigger semi-persistent CSI reporting on a PUSCH resource.

In some aspects, the indication for triggering downlink CSI reporting for MT-SDT may be included in a medium access control (MAC) control element (MAC-CE) included in the paging message. In some aspects, a semi-persistent CSI state MAC-CE, transmitted in the paging message, may provide an indication for triggering semi-persistent CSI reporting for MT-SDT. For example, the MAC-CE (e.g., the semi-persistent CSI state MAC-CE) included in the paging message may trigger semi-persistent CSI reporting on a PUSCH resource.

In some aspects, the indication for triggering downlink CSI reporting for MT-SDT may be an indication, included in the paging message, of a dedicated uplink resource (e.g., an uplink grant). For example, the indication, in the paging message, of the dedicated uplink resource may provide an indication, to the UE 120, that aperiodic CSI reporting for MT-SDT is triggered. In this case, the indication in the paging message of the dedicated uplink resource may trigger the UE 120 to use the indicated dedicated uplink resource to report aperiodic CSI for MT-SDT.

In some aspects, when the paging DCI or the paging message includes the indication for triggering downlink CSI reporting for MT-SDT, the UE 120 may determine whether a UE ID indicated in the paging message (e.g., the UE resume ID) matches the UE ID of the UE 120. For example, the paging message may indicate one or more UE IDs (e.g., one or more UE resume IDs), and the UE 120 may determine whether the one or more UE IDs indicated in the paging message include the UE ID of the UE 120. If the paging DCI or the paging message includes the indication for triggering downlink CSI reporting for MT-SDT and the one or more UE IDs indicated in the paging message include the UE ID of the UE 120, the downlink CSI reporting for MT-SDT (e.g., aperiodic or semi-persistent downlink CSI reporting) may be triggered for the UE 120. In this case, the UE 120 may proceed with the downlink CSI reporting MT-SDT. If the paging DCI or the paging message includes the indication for triggering downlink CSI reporting for MT-SDT, but the one or more UE IDs indicated in the paging message do not include the UE ID of the UE 120, the UE 120 may ignore the indication for triggering downlink CSI reporting for MT-SDT.

As further shown in FIG. 8, and by reference number 806, the UE 120 may transmit, to the network node 110, a MsgA including a random access preamble and a PUSCH payload. In some aspects, the UE 120 may transmit the MsgA to initiate a two-step RACH procedure based at least in part on receiving the paging message for triggering MT-SDT. In some aspects, the UE 120 may transmit, in the MsgA, the dedicated random access preamble indicated in the paging message, and the UE 120 may transmit a resumeMAC-I in the MsgA PUSCH resource. The dedicated random access preamble may be a dedicated PRACH preamble that corresponds to a dedicated RACH resource for the UE 120 to use for the two-step RACH procedure. In some aspects, the dedicated random access preamble, transmitted by the UE 120, may provide, to the network node 110, an implicit acknowledgement that the UE 120 received the paging message. In this case, a common control channel (CCCH) message may not be needed in the RACH procedure. For example, the UE 120 may transmit the MsgA PUSCH payload that includes the resumeMAC-I, without transmitting the CCCH message in the MsgA PUSCH payload. The resumeMAC-I is an authentication token, which may be transmitted in the MsgA PUSCH payload to serve as a security verification. For example, the resumeMAC-I may be transmitted in the MsgA PUSCH payload via a MAC-CE or RRC signaling.

As shown by reference number 808, the network node 110 may transmit, to the UE 120, a network response (MsgB). The UE 120 may receive the network response (MsgB) transmitted by the network node 110. The network response may indicate contention resolution. For example, the network response may indicate that contention resolution is successful for the UE 120.

In some aspects, a two-step RACH procedure may be used to initiate MT-SDT for the UE 120, as shown in FIG. 8. In some aspects, a four-step RACH procedure may be used to initiate MT-SDT for the UE 120. In this case, based at least in part on receiving the paging message, the UE 120 may transmit, to the network node 110, a random access preamble (e.g., the dedicated random access preamble indicated in the paging message) (Msg1); the network node 110 may transmit, to the UE 120, a random access response (Msg2); the UE 120 may transmit, to the network node 110, a first uplink message (Msg3) including an RRC resume request; and the network node 110 may transmit, to the UE 120, a network response (Msg4) that indicates contention resolution. In some aspects, a CG-based procedure may be used to initiate MT-SDT for the UE 120. In the CG-based procedure, the RRC release message may include a CG resource configuration that indicates a configured PUSCH resource for transmitting uplink data in the RRC inactive state. In this case, based at least in part on receiving the paging message, the UE 120 may transmit, to the network node 110, a first uplink message, including an RRC resume request and uplink data, using the configured PUSCH resource, and the network node 110 may transmit, to the UE 120, a network response that indicates contention resolution.

After contention resolution, subsequent data transmissions may occur between the network node 110 and the UE 120. For example, the UE 120, while in the RRC inactive mode, may transmit one or more CSI reports to the network node 110 based at least in part on the indication, in the paging DCI or the paging message, for triggering downlink CSI reporting for MT-SDT. Additionally, or alternatively, the UE 120, based at least in part on the indication that activates the SPS resource configuration for MT-SDT, may use the periodically reoccurring SPS resource (e.g., PDSCH resource) to receive transmissions of downlink small data (e.g., downlink user data or signaling) from the network node 110 in one or more SPS occasions while operating in the RRC inactive mode.

As shown by reference number 810, the UE 120, while in the RRC inactive mode, may transmit, to the network node 110, a CSI report based at least in part on the indication, included in the paging DCI or the paging message, for triggering downlink CSI reporting for MT-SDT. The network node 110 may receive the CSI report transmitted by the UE 120. In some aspects, the UE 120 may transmit the CSI report on an uplink resource (e.g., a PUCCH resource or a PUSCH resource) indicated in the CSI report configuration included in the RRC release message. In some aspects, the UE 120 may transmit the CSI report on an uplink resource (e.g., a PUCCH resource or a PUSCH resource) indicated in the paging message.

In some aspects, the UE 120 may perform CSI measurements of reference signals (e.g., CSI-RSs and/or SSBs) on one or more reference signal resources. For example, the reference signal resources to be used for the CSI measurements may be indicated in a CSI measurement configuration, included in the RRC release measurement, and/or the paging message. In some aspects, the paging message may indicate one or more candidate reference signal resources of the set of reference signal resources included in the resource pool configured in the CSI measurement configuration. In this case, the UE 120 may perform CSI measurements on the one or more candidate reference signal resources indicated in the paging message. The CSI report may be based at least in part on the CSI measurements performed by the UE 120.

For example, the CSI report may indicate downlink channel quality based at least in part on the CSI measurements. In some aspects, based at least in part on the CSI measurements, the UE 120 may perform channel estimation and may report channel estimation parameters to the network node 110 (e.g., in the CSI report), such as a CQI, a precoding matrix indicator (PMI), a CSI-RS resource indicator (CRI), a layer indicator (LI), a rank indicator (RI), or an RSRP, among other examples.

In some aspects, the network node 110 may determine one or more transmission parameters for transmitting of downlink data to the UE 120 while the UE 120 is in the RRC inactive state (e.g., for MT-SDT) based at least in part on the CSI report received from the UE 120. In some aspects, the network node 110 may select an MCS for SPS transmissions of downlink data to the UE 120 while the UE 120 is in the RRC inactive state based at least in part on the CSI report. Additionally, or alternatively, the network node 110 may select other transmission parameters for the SPS transmissions of downlink data to the UE 120 while the UE 120 is in the RRC inactive state based at least in part on the CSI report. In some aspects, the network node 110 may select the MCS and/or other transmission parameters for transmissions of downlink data to the UE 120 while the UE 120 is in the RRC inactive state (e.g., MT-SDT) scheduled by dynamic grants based at least in part on the CSI report received from the UE 120.

As further shown in FIG. 8, and by reference numbers 812, 814, and 818, the UE 120, based at least in part on the indication, included in the paging DCI or the paging message, that activates an SPS resource for downlink data reception in the RRC inactive state, may monitor the SPS resource in a plurality of SPS occasions. The SPS resource may be a PDSCH resource indicated in the SPS resource configuration for MT-SDT, and SPS occasions may occur at the periodicity indicated in the SPS configuration included in the SPS resource configured for MT-SDT. The network node 110 may transmit downlink data to the UE 120 via the SPS resource (e.g., the configured PDSCH resource) in one or more SPS occasions of the plurality of SPS occasions. The UE 120, while in the RRC inactive mode, may receive the transmissions of downlink data via the SPS resource (e.g., the configured PDSCH resource) in the one or more SPS occasions. In some aspects, the transmissions of downlink data, from the network node 110 to the UE 120, via the SPS resource in the one or more SPS occasions, may be MT-SDTs. For example, the downlink data transmitted to the UE 120 via the SPS resource in the one or more SPS occasions may include downlink user data or signaling.

As shown by reference number 816, in some aspects, the UE 120 may transmit, to the network node 110, uplink data in response to the downlink data received, via the SPS. The network node 110 may receive the uplink data transmitted by the UE 120.

As shown by reference number 820, the network node 110 may transmit, to the UE 120, an RRC release message (e.g., RRCRelease) or an RRC resume message (e.g., RRCResume). For example, the RRC release message may be an RRC release message with a suspend configuration (e.g., SuspendConfig). The UE 120 may receive the RRC release message or the RRC resume message transmitted by the network node 110. In some aspects, the RRC release message or the RRC resume message may terminate MT-SDT for the UE 120. For example, receiving the RRC release message or the RRC resume message may terminate downlink data reception for the UE 120 in the RRC inactive mode. In this case, the UE 120 may stop using the periodically reoccurring SPS resource for receiving transmissions of downlink data from the network node 110, in connection with the UE 120 receiving the RRC release message or the RRC resume message.

In some aspects, after transmitting the MsgA to the network node 110, the UE 120 may monitor for PDCCH communications associated with a random access radio network temporary identifier (RA-RNTI), PDCCH communications associated with a cell radio network temporary identifier (C-RNTI), and PDCCH communications associated with a configured scheduling radio network temporary identifier (CS-RNTI). The UE 120 may monitor for PDCCH communications associated with RA-RNTI for reception of a fallback random access response from the network node 110. In some aspects, the UE 120 may monitor for PDCCH communications associated with C-RNTI for a dynamic grant, transmitted by the network node 110, that schedules downlink data reception in the RRC inactive state. In some aspects, the UE 120 may monitor for PDCCH communications associated with CS-RNTI for a new SPS downlink assignment or retransmission.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with paging triggered SPS resource activation for MT-SDT.

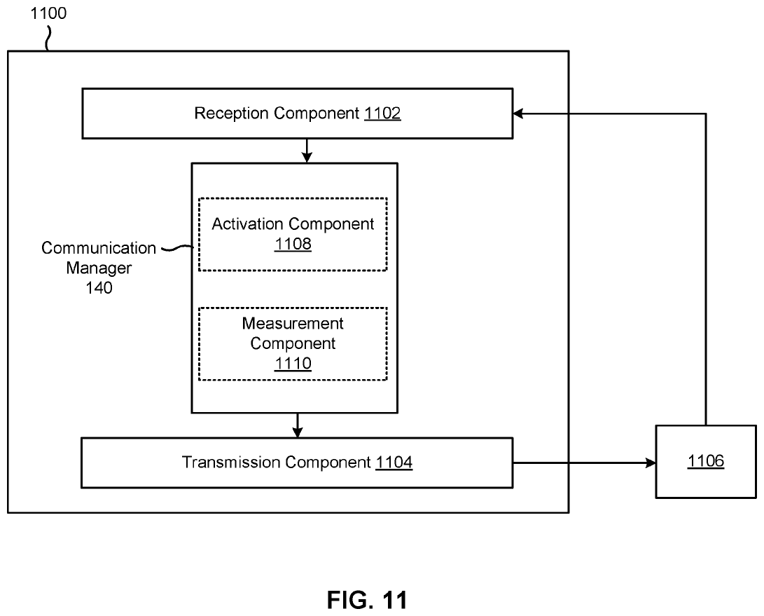

As shown in FIG. 9, in some aspects, process 900 may include receiving, from a network node, a configuration of an SPS resource for downlink data reception in an inactive state (block 910). For example, the UE (e.g., using communication manager 140 and/or reception component 1102, depicted in FIG. 11) may receive, from a network node, a configuration of an SPS resource for downlink data reception in an inactive state, as described above.

As further shown in FIG. 9, in some aspects, process 900 may include receiving, from the network node and while operating in the inactive state, paging DCI and a paging message for triggering downlink data reception in the inactive state, wherein the paging DCI or the paging message includes an indication that activates the SPS resource for downlink data reception in the inactive state (block 920). For example, the UE (e.g., using communication manager 140 and/or reception component 1102, depicted in FIG. 11) may receive, from a network node and while operating in the inactive state, paging DCI and a paging message for triggering downlink data reception in the inactive state, wherein the paging DCI or the paging message includes an indication that activates the SPS resource for downlink data reception in the inactive state, as described above.

As further shown in FIG. 9, in some aspects, process 900 may include receiving, from the network node and while operating in the inactive state, one or more transmissions of downlink data via the SPS resource for downlink data reception in the inactive state (block 930). For example, the UE (e.g., using communication manager 140 and/or reception component 1102, depicted in FIG. 11) may receive, from the network node and while operating in the inactive state, one or more transmissions of downlink data via the SPS resource for downlink data reception in the inactive state, as described above.

Process 900 may include additional aspects, such as any single aspect or any combination of aspects described below and/or in connection with one or more other processes described elsewhere herein.

In a first aspect, the one or more transmissions of downlink data include one or more transmissions of downlink user data or signaling.

In a second aspect, the configuration of the SPS resource downlink data reception in the inactive state includes an SPS configuration and an indication of an SPS PDSCH resource to be used for downlink data reception in the inactive state in accordance with the SPS configuration.

In a third aspect, receiving the configuration of the SPS resource for downlink data reception in the inactive state includes receiving, while operating in an RRC connected state, an RRC release message that indicates the configuration of the SPS resource for downlink data reception in the inactive state.

In a fourth aspect, the RRC release message indicates respective configurations for one or more SPS resources for downlink data reception in the inactive state.

In a fifth aspect, a quantity of the one or more SPS resources for which respective configurations are included in the RRC release message is based at least in part on a reported capability of the UE for supporting configurations of multiple SPS resources for downlink data reception in the inactive state.

In a sixth aspect, receiving the configuration of the SPS resource for downlink data reception in the inactive state includes receiving, from the network node, system information that indicates the configuration of the SPS resource for downlink data reception in the inactive state.

In a seventh aspect, process 900 includes transmitting, to the network node, an indication of a UE capability for SPS reception of MT-SDT, wherein receiving the configuration of the SPS resource for downlink data reception in the inactive state is based at least in part on the indication of the UE capability for SPS reception of MT-SDT.

In an eighth aspect, the paging DCI includes the indication that activates the SPS resource for downlink data reception in the inactive state.

In a ninth aspect, the paging message indicates at least one UE identifier, and process 900 includes activating the SPS resource for downlink data reception in the inactive state based at least in part on the paging DCI including the indication that activates the SPS resource for downlink data reception in the inactive state and based at least in part on a determination that the at least one UE identifier, indicated in the paging message, includes a UE identifier of the UE.

In a tenth aspect, the paging message includes the indication that activates the SPS resource for downlink data reception in the inactive state.

In an eleventh aspect, the paging message indicates at least one UE identifier, and process 900 includes activating the SPS resource for downlink data reception in the inactive state based at least in part on the paging message including the indication that activates the SPS resource for downlink data reception in the inactive state and based at least in part on a determination that the at least one UE identifier, indicated in the paging message, includes a UE identifier of the UE.

In a twelfth aspect, the paging DCI or the paging message includes an indication for triggering downlink CSI reporting for downlink data reception in the inactive state, and process 900 includes transmitting, to the network node while operating in the inactive state, a CSI report based at least in part on the indication for triggering downlink CSI reporting for downlink data reception in the inactive state.

In a thirteenth aspect, process 900 includes receiving, from the network node while operating in an RRC connected state, an RRC release message that includes at least one of a CSI report configuration or a CSI measurement configuration for downlink CSI reporting for downlink data reception in the inactive state.

In a fourteenth aspect, the RRC release message includes the CSI report configuration, the CSI report configuration indicates an uplink resource for CSI reporting, and transmitting the CSI report includes transmitting the CSI report on the uplink resource for CSI reporting.

In a fifteenth aspect, the uplink resource for CSI reporting includes at least one of a PUCCH resource for periodic CSI reporting or a PUSCH resource for aperiodic CSI reporting.

In a sixteenth aspect, the RRC release message includes the CSI measurement configuration, the CSI measurement configuration indicates a configuration of a resource pool including a set of reference signal resources, the paging message indicates one or more candidate reference signal resources of the set of reference signal resources included in the resource pool, and process 900 includes performing CSI measurements on the one or more candidate reference signal resources while operating in the inactive state, wherein the CSI report is based at least in part on the CSI measurements on the one or more candidate reference signal resources.

In a seventeenth aspect, the paging message indicates an uplink resource for CSI reporting, and transmitting the CSI report includes transmitting the CSI report on the uplink resource for CSI reporting.

In an eighteenth aspect, the indication for triggering downlink CSI reporting for downlink data reception in the inactive state is included in a CSI request field of the paging DCI.

In a nineteenth aspect, the indication for triggering downlink CSI reporting for downlink data reception in the inactive state is included in a MAC-CE that is included in the paging message.

In a twentieth aspect, the indication for triggering downlink CSI reporting for downlink data reception in the inactive state is an indication, included in the paging message, of a dedicated uplink resource, and transmitting the CSI report includes transmitting the CSI report on the dedicated uplink resource.

In a twenty-first aspect, transmitting the CSI report includes transmitting the CSI report based at least in part on the paging DCI or the paging message including the indication for triggering downlink CSI reporting for MT-SDT and based at least in part on a determination that a UE identifier of the UE is indicated in the paging message.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with paging triggered SPS resource activation for MT-SDT.

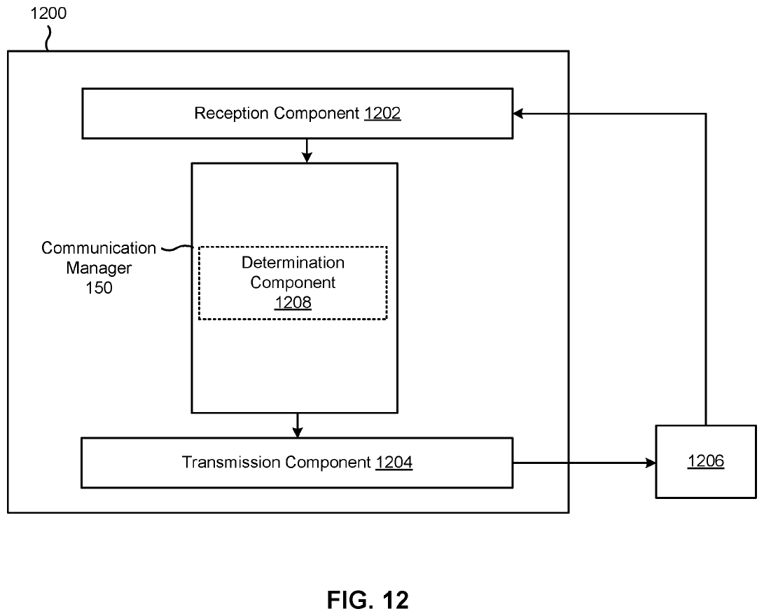

As shown in FIG. 10, in some aspects, process 1000 may include transmitting, to a UE, a configuration of an SPS resource for downlink data reception in an inactive state (block 1010). For example, the network node (e.g., using communication manager 150 and/or transmission component 1204, depicted in FIG. 12) may transmit, to a UE, a configuration of an SPS resource for downlink data reception in an inactive state, as described above.

As further shown in FIG. 10, in some aspects, process 1000 may include transmitting, to the UE while the UE is in the inactive state, paging DCI and a paging message for triggering downlink data reception in the inactive state, wherein the paging DCI or the paging message includes an indication that activates the SPS resource for downlink data reception in the inactive state (block 1020). For example, the network node (e.g., using communication manager 150 and/or transmission component 1204, depicted in FIG. 12) may transmit, to the UE while the UE is in the inactive state, paging DCI and a paging message for triggering downlink data reception in the inactive state, wherein the paging DCI or the paging message includes an indication that activates the SPS resource for downlink data reception in the inactive state, as described above.

As further shown in FIG. 10, in some aspects, process 1000 may include transmitting, to the UE while the UE is in the inactive state, one or more transmissions of downlink data via the SPS resource for downlink data reception in the inactive state (block 1030). For example, the network node (e.g., using communication manager 150 and/or transmission component 1204, depicted in FIG. 12) may transmit, to the UE while the UE is in the inactive state, one or more transmissions of downlink data via the SPS resource for downlink data reception in the inactive state, as described above.

Process 1000 may include additional aspects, such as any single aspect or any combination of aspects described below and/or in connection with one or more other processes described elsewhere herein.

In a first aspect, the one or more transmissions of downlink data include one or more transmissions of downlink user data or signaling.

In a second aspect, the configuration of the SPS resource downlink data reception in the inactive state includes an SPS configuration and an indication of an SPS PDSCH resource to be used for downlink data reception in the inactive state in accordance with the SPS configuration.

In a third aspect, transmitting the configuration of the SPS resource for downlink data reception in the inactive state includes transmitting, to the UE while the UE is operating in an RRC connected state, an RRC release message that indicates the configuration of the SPS resource for downlink data reception in the inactive state.

In a fourth aspect, the RRC release message indicates respective configurations for one or more SPS resources for downlink data reception in the inactive state.

In a fifth aspect, a quantity of the one or more SPS resources for which respective configurations are included in the RRC release message is based at least in part on a reported capability of the UE for supporting configurations of multiple SPS resources for downlink data reception in the inactive state.

In a sixth aspect, transmitting the configuration of the SPS resource for downlink data reception in the inactive state includes transmitting, to the UE, system information that indicates the configuration of the SPS resource for downlink data reception in the inactive state.

In a seventh aspect, process 1000 includes receiving, from the UE, an indication of a UE capability for SPS reception of MT-SDT, wherein transmitting the configuration of the SPS resource for downlink data reception in the inactive state is based at least in part on the indication of the UE capability for SPS reception of MT-SDT.

In an eighth aspect, the paging DCI includes the indication that activates the SPS resource for downlink data reception in the inactive state.

In a ninth aspect, the paging message includes the indication that activates the SPS resource for downlink data reception in the inactive state.

In a tenth aspect, the paging DCI or the paging message includes an indication for triggering downlink CSI reporting for downlink data reception in the inactive state, and process 1000 includes receiving, from the UE while the UE is operating in the inactive state, a CSI report based at least in part on the indication for triggering downlink CSI reporting for downlink data reception in the inactive state.

In an eleventh aspect, process 1000 includes transmitting, to the UE while the UE is operating in an RRC connected state, an RRC release message that includes at least one of a CSI report configuration or a CSI measurement configuration for downlink CSI reporting for downlink data reception in the inactive state.

In a twelfth aspect, the RRC release message includes the CSI report configuration, the CSI report configuration indicates an uplink resource for CSI reporting, and receiving the CSI report includes receiving the CSI report on the uplink resource for CSI reporting.

In a thirteenth aspect, the uplink resource for CSI reporting includes at least one of a PUCCH resource for periodic CSI reporting or a PUSCH resource for aperiodic CSI reporting.

In a fourteenth aspect, the RRC release message includes the CSI measurement configuration, the CSI measurement configuration indicates a configuration of a resource pool including a set of reference signal resources, the paging message indicates one or more candidate reference signal resources of the set of reference signal resources included in the resource pool, and the CSI report is based at least in part on CSI measurements on the one or more candidate reference signal resources.

In a fifteenth aspect, the paging message indicates an uplink resource for CSI reporting, and receiving the CSI report includes receiving the CSI report on the uplink resource for CSI reporting.

In a sixteenth aspect, the indication for triggering downlink CSI reporting for downlink data reception in the inactive state is included in a CSI request field of the paging DCI.

In a seventeenth aspect, the indication for triggering downlink CSI reporting for downlink data reception in the inactive state is included in a MAC-CE that is included in the paging message.

In an eighteenth aspect, the indication for triggering downlink CSI reporting for downlink data reception in the inactive state is an indication, included in the paging message, of a dedicated uplink resource, and receiving the CSI report includes receiving the CSI report on the dedicated uplink resource.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of an activation component 1108 and/or a measurement component 1110, among other examples.

In some aspects, the apparatus 1100 may be configured to perform one or more operations described herein in connection with FIG. 8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive, from a network node, a configuration of an SPS resource for downlink data reception in an inactive state. The reception component 1102 may receive, from the network node and while operating in the inactive state, paging DCI and a paging message for triggering downlink data reception in the inactive state, wherein the paging DCI or the paging message includes an indication that activates the SPS resource for downlink data reception in the inactive state. The reception component 1102 may receive, from the network node and while operating in the inactive state, one or more transmissions of downlink data via the SPS resource for downlink data reception in the inactive state.

The transmission component 1104 may transmit, to the network node, an indication of a UE capability for SPS reception of MT-SDT.

The activation component 1108 may activate the SPS resource for downlink data reception in the inactive state based at least in part on the paging DCI including the indication that activates the SPS resource for downlink data reception in the inactive state and based at least in part on a determination that the at least one UE identifier, indicated in the paging message, includes a UE identifier of the UE.

The activation component 1108 may activate the SPS resource for downlink data reception in the inactive state based at least in part on the paging message including the indication that activates the SPS resource for downlink data reception in the inactive state and based at least in part on a determination that the at least one UE identifier, indicated in the paging message, includes a UE identifier of the UE.

The transmission component 1104 may transmit, to the network node while operating in the inactive state, a CSI report based at least in part on the indication for triggering downlink CSI reporting for downlink data reception in the inactive state.

The reception component 1102 may receive, from the network node while operating in an RRC connected state, an RRC release message that includes at least one of a CSI report configuration or a CSI measurement configuration for downlink CSI reporting for downlink data reception in the inactive state.

The measurement component 1110 may perform CSI measurements on one or more candidate reference signal resources while operating in the inactive state, wherein the CSI report is based at least in part on the CSI measurements on the one or more candidate reference signal resources.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a determination component 1208, among other examples.

In some aspects, the apparatus 1200 may be configured to perform one or more operations described herein in connection with FIG. 8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The transmission component 1204 may transmit, to a UE, a configuration of an SPS resource for downlink data reception in an inactive state. The transmission component 1204 may transmit, to the UE while the UE is in the inactive state, paging DCI and a paging message for triggering downlink data reception in the inactive state, wherein the paging DCI or the paging message includes an indication that activates the SPS resource for downlink data reception in the inactive state. The transmission component 1204 may transmit, to the UE while the UE is in the inactive state, one or more transmissions of downlink data via the SPS resource for downlink data reception in the inactive state.

The determination component 1208 may determine the configuration of the SPS resource for downlink data reception in the inactive state.

The reception component 1202 may receive, from the UE, an indication of a UE capability for SPS reception of MT-SDT.

The reception component 1202 may receive, from the UE while the UE is operating in the inactive state, a CSI report based at least in part on the indication for triggering downlink CSI reporting for downlink data reception in the inactive state.

The transmission component 1204 may transmit, to the UE while the UE is operating in an RRC connected state, an RRC release message that includes at least one of a CSI report configuration or a CSI measurement configuration for downlink CSI reporting for downlink data reception in the inactive state.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving, from a network node, a configuration of a semi-persistent scheduling (SPS) resource for downlink data reception in an inactive state; receiving, from the network node and while operating in the inactive state, paging downlink control information (DCI) and a paging message for triggering downlink data reception in the inactive state, wherein the paging DCI or the paging message includes an indication that activates the SPS resource for downlink data reception in the inactive state; and receiving, from the network node and while operating in the inactive state, one or more transmissions of downlink data via the SPS resource for downlink data reception in the inactive state.

Aspect 2: The method of Aspect 1, wherein the one or more transmissions of downlink data include one or more transmissions of downlink user data or signaling.

Aspect 3: The method of any of Aspects 1-2, wherein the configuration of the SPS resource downlink data reception in the inactive state includes an SPS configuration and an indication of an SPS physical downlink shared channel (PDSCH) resource to be used for downlink data reception in the inactive state in accordance with the SPS configuration.

Aspect 4: The method of any of Aspects 1-3, wherein receiving the configuration of the SPS resource for downlink data reception in the inactive state comprises: receiving, while operating in a radio resource control (RRC) connected state, an RRC release message that indicates the configuration of the SPS resource for downlink data reception in the inactive state.

Aspect 5: The method of Aspect 4, wherein the RRC release message indicates respective configurations for one or more SPS resources for downlink data reception in the inactive state.

Aspect 6: The method of Aspect 5, wherein a quantity of the one or more SPS resources for which respective configurations are included in the RRC release message is based at least in part on a reported capability of the UE for supporting configurations of multiple SPS resources for downlink data reception in the inactive state.

Aspect 7: The method of any of Aspects 1-3, wherein receiving the configuration of the SPS resource for downlink data reception in the inactive state comprises: receiving, from the network node, system information that indicates the configuration of the SPS resource for downlink data reception in the inactive state.

Aspect 8: The method of any of Aspects 1-7, further comprising: transmitting, to the network node, an indication of a UE capability for SPS reception of mobile terminated small data transmission (MT-SDT), wherein receiving the configuration of the SPS resource for downlink data reception in the inactive state is based at least in part on the indication of the UE capability for SPS reception of MT-SDT.

Aspect 9: The method of any of Aspects 1-8, wherein the paging DCI includes the indication that activates the SPS resource for downlink data reception in the inactive state.

Aspect 10: The method of Aspect 9, wherein the paging message indicates at least one UE identifier, and further comprising: activating the SPS resource for downlink data reception in the inactive state based at least in part on the paging DCI including the indication that activates the SPS resource for downlink data reception in the inactive state and based at least in part on a determination that the at least one UE identifier, indicated in the paging message, includes a UE identifier of the UE.

Aspect 11: The method of any of Aspects 1-8, wherein the paging message includes the indication that activates the SPS resource for downlink data reception in the inactive state.

Aspect 12: The method of Aspect 11, wherein the paging message indicates at least one UE identifier, and further comprising: activating the SPS resource for downlink data reception in the inactive state based at least in part on the paging message including the indication that activates the SPS resource for downlink data reception in the inactive state and based at least in part on a determination that the at least one UE identifier, indicated in the paging message, includes a UE identifier of the UE.

Aspect 13: The method of any of Aspects 1-12, wherein the paging DCI or the paging message includes an indication for triggering downlink channel state information (CSI) reporting for downlink data reception in the inactive state, and further comprising: transmitting, to the network node while operating in the inactive state, a CSI report based at least in part on the indication for triggering downlink CSI reporting for downlink data reception in the inactive state.

Aspect 14: The method of Aspect 13, further comprising: receiving, from the network node while operating in an RRC connected state, an RRC release message that includes at least one of a CSI report configuration or a CSI measurement configuration for downlink CSI reporting for downlink data reception in the inactive state.

Aspect 15: The method of Aspect 14, wherein the RRC release message includes the CSI report configuration, wherein the CSI report configuration indicates an uplink resource for CSI reporting, and wherein transmitting the CSI report comprises: transmitting the CSI report on the uplink resource for CSI reporting.

Aspect 16: The method of Aspect 15, wherein the uplink resource for CSI reporting includes at least one of a physical uplink control channel (PUCCH) resource for periodic CSI reporting or a physical uplink shared channel (PUSCH) resource for aperiodic CSI reporting.

Aspect 17: The method of any of Aspects 14-16, wherein the RRC release message includes the CSI measurement configuration, wherein the CSI measurement configuration indicates a configuration of a resource pool including a set of reference signal resources, wherein the paging message indicates one or more candidate reference signal resources of the set of reference signal resources included in the resource pool, and further comprising: performing CSI measurements on the one or more candidate reference signal resources while operating in the inactive state, wherein the CSI report is based at least in part on the CSI measurements on the one or more candidate reference signal resources.

Aspect 18: The method of any of Aspects 13-14 and 17, wherein the paging message indicates an uplink resource for CSI reporting, and wherein transmitting the CSI report comprises: transmitting the CSI report on the uplink resource for CSI reporting.

Aspect 19: The method of any of Aspects 13-18, wherein the indication for triggering downlink CSI reporting for downlink data reception in the inactive state is included in a CSI request field of the paging DCI.

Aspect 20: The method of any of Aspects 13-18, wherein the indication for triggering downlink CSI reporting for downlink data reception in the inactive state is included in a medium access control (MAC) control element (MAC-CE) that is included in the paging message.

Aspect 21: The method of any of Aspects 13-18, wherein the indication for triggering downlink CSI reporting for downlink data reception in the inactive state is an indication, included in the paging message, of a dedicated uplink resource, and wherein transmitting the CSI report comprises: transmitting the CSI report on the dedicated uplink resource.

Aspect 22: The method of any of Aspects 13-21, wherein transmitting the CSI report comprises: transmitting the CSI report based at least in part on the paging DCI or the paging message including the indication for triggering downlink CSI reporting for MT-SDT and based at least in part on a determination that a UE identifier of the UE is indicated in the paging message.

Aspect 23: A method of wireless communication performed by a network node, comprising: transmitting, to a user equipment (UE), a configuration of a semi-persistent scheduling (SPS) resource for downlink data reception in an inactive state; transmitting, to the UE while the UE is in the inactive state, paging downlink control information (DCI) and a paging message for triggering downlink data reception in the inactive state, wherein the paging DCI or the paging message includes an indication that activates the SPS resource for downlink data reception in the inactive state; and transmitting, to the UE while the UE is in the inactive state, one or more transmissions of downlink data via the SPS resource for downlink data reception in the inactive state.

Aspect 24: The method of Aspect 23, wherein the one or more transmissions of downlink data include one or more transmissions of downlink user data or signaling.

Aspect 25: The method of any of Aspects 23-24, wherein the configuration of the SPS resource downlink data reception in the inactive state includes an SPS configuration and an indication of an SPS physical downlink shared channel (PDSCH) resource to be used for downlink data reception in the inactive state in accordance with the SPS configuration.

Aspect 26: The method of any of Aspects 23-25, wherein transmitting the configuration of the SPS resource for downlink data reception in the inactive state comprises: transmitting, to the UE while the UE is operating in a radio resource control (RRC) connected state, an RRC release message that indicates the configuration of the SPS resource for downlink data reception in the inactive state.

Aspect 27: The method of Aspect 26, wherein the RRC release message indicates respective configurations for one or more SPS resources for downlink data reception in the inactive state.

Aspect 28: The method of Aspect 27, wherein a quantity of the one or more SPS resources for which respective configurations are included in the RRC release message is based at least in part on a reported capability of the UE for supporting configurations of multiple SPS resources for downlink data reception in the inactive state.

Aspect 29: The method of any of Aspects 23-25, wherein transmitting the configuration of the SPS resource for downlink data reception in the inactive state comprises: transmitting, to the UE, system information that indicates the configuration of the SPS resource for downlink data reception in the inactive state.

Aspect 30: The method of any of Aspects 23-29, further comprising: receiving, from the UE, an indication of a UE capability for SPS reception of mobile terminated small data transmission (MT-SDT), wherein transmitting the configuration of the SPS resource for downlink data reception in the inactive state is based at least in part on the indication of the UE capability for SPS reception of MT-SDT.

Aspect 31: The method of any of Aspects 23-30, wherein the paging DCI includes the indication that activates the SPS resource for downlink data reception in the inactive state.

Aspect 32: The method of any of Aspects 23-30, wherein the paging message includes the indication that activates the SPS resource for downlink data reception in the inactive state.

Aspect 33: The method of any of Aspects 23-32, wherein the paging DCI or the paging message includes an indication for triggering downlink channel state information (CSI) reporting for downlink data reception in the inactive state, and further comprising: receiving, from the UE while the UE is operating in the inactive state, a CSI report based at least in part on the indication for triggering downlink CSI reporting for downlink data reception in the inactive state.

Aspect 34: The method of Aspect 33, further comprising: transmitting, to the UE while the UE is operating in an RRC connected state, an RRC release message that includes at least one of a CSI report configuration or a CSI measurement configuration for downlink CSI reporting for downlink data reception in the inactive state.

Aspect 35: The method of Aspect 34, wherein the RRC release message includes the CSI report configuration, wherein the CSI report configuration indicates an uplink resource for CSI reporting, and wherein receiving the CSI report comprises: receiving the CSI report on the uplink resource for CSI reporting.

Aspect 36: The method of Aspect 35, wherein the uplink resource for CSI reporting includes at least one of a physical uplink control channel (PUCCH) resource for periodic CSI reporting or a physical uplink shared channel (PUSCH) resource for aperiodic CSI reporting.

Aspect 37: The method of any of Aspects 34-36, wherein the RRC release message includes the CSI measurement configuration, wherein the CSI measurement configuration indicates a configuration of a resource pool including a set of reference signal resources, wherein the paging message indicates one or more candidate reference signal resources of the set of reference signal resources included in the resource pool, and wherein the CSI report is based at least in part on CSI measurements on the one or more candidate reference signal resources.

Aspect 38: The method of any of Aspects 33-34 and 37, wherein the paging message indicates an uplink resource for CSI reporting, and wherein receiving the CSI report comprises: receiving the CSI report on the uplink resource for CSI reporting.

Aspect 39: The method of any of Aspects 33-38, wherein the indication for triggering downlink CSI reporting for downlink data reception in the inactive state is included in a CSI request field of the paging DCI.

Aspect 40: The method of any of Aspects 33-38, wherein the indication for triggering downlink CSI reporting for downlink data reception in the inactive state is included in a medium access control (MAC) control element (MAC-CE) that is included in the paging message.

Aspect 41: The method of any of Aspects 33-38, wherein the indication for triggering downlink CSI reporting for downlink data reception in the inactive state is an indication, included in the paging message, of a dedicated uplink resource, and wherein receiving the CSI report comprises: receiving the CSI report on the dedicated uplink resource.

Aspect 42: An apparatus for wireless communication at a device, comprising a processor; memory coupled with the processor; and instructions stored in the memory and executable by the processor to cause the apparatus to perform the method of one or more of Aspects 1-22.

Aspect 43: A device for wireless communication, comprising a memory and one or more processors coupled to the memory, the one or more processors configured to perform the method of one or more of Aspects 1-22.

Aspect 44: An apparatus for wireless communication, comprising at least one means for performing the method of one or more of Aspects 1-22.

Aspect 45: A non-transitory computer-readable medium storing code for wireless communication, the code comprising instructions executable by a processor to perform the method of one or more of Aspects 1-22.

Aspect 46: A non-transitory computer-readable medium storing a set of instructions for wireless communication, the set of instructions comprising one or more instructions that, when executed by one or more processors of a device, cause the device to perform the method of one or more of Aspects 1-22.

Aspect 47: An apparatus for wireless communication at a device, comprising a processor; memory coupled with the processor; and instructions stored in the memory and executable by the processor to cause the apparatus to perform the method of one or more of Aspects 23-41.

Aspect 48: A device for wireless communication, comprising a memory and one or more processors coupled to the memory, the one or more processors configured to perform the method of one or more of Aspects 23-41.

Aspect 49: An apparatus for wireless communication, comprising at least one means for performing the method of one or more of Aspects 23-41.

Aspect 50: A non-transitory computer-readable medium storing code for wireless communication, the code comprising instructions executable by a processor to perform the method of one or more of Aspects 23-41.

Aspect 51: A non-transitory computer-readable medium storing a set of instructions for wireless communication, the set of instructions comprising one or more instructions that, when executed by one or more processors of a device, cause the device to perform the method of one or more of Aspects 23-41.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a network node, a configuration of a semi-persistent scheduling (SPS) resource for downlink data reception in an inactive state;
receive, from the network node and while operating in the inactive state, paging downlink control information (DCI) and a paging message for triggering downlink data reception in the inactive state, wherein the paging DCI or the paging message includes an indication that activates the SPS resource for downlink data reception in the inactive state; and
receive, from the network node and while operating in the inactive state, one or more transmissions of downlink data via the SPS resource for downlink data reception in the inactive state.

2. The UE of claim 1, wherein the one or more transmissions of downlink data include one or more transmissions of downlink user data or signaling.

3. The UE of claim 1, wherein the configuration of the SPS resource downlink data reception in the inactive state includes an SPS configuration and an indication of an SPS physical downlink shared channel (PDSCH) resource to be used for downlink data reception in the inactive state in accordance with the SPS configuration.

4. The UE of claim 1, wherein the one or more processors, to receive the configuration of the SPS resource for downlink data reception in the inactive state, are configured to:
receive, while operating in a radio resource control (RRC) connected state, an RRC release message that indicates the configuration of the SPS resource for downlink data reception in the inactive state.

5. The UE of claim 4, wherein the RRC release message indicates respective configurations for one or more SPS resources for downlink data reception in the inactive state.

6. The UE of claim 5, wherein a quantity of the one or more SPS resources for which respective configurations are included in the RRC release message is based at least in part on a reported capability of the UE for supporting configurations of multiple SPS resources for downlink data reception in the inactive state.

7. The UE of claim 1, wherein the one or more processors, to receive the configuration of the SPS resource for downlink data reception in the inactive state, are configured to:
receive, from the network node, system information that indicates the configuration of the SPS resource for downlink data reception in the inactive state.

8. The UE of claim 1, wherein the one or more processors are further configured to:
transmit, to the network node, an indication of a UE capability for SPS reception of mobile terminated small data transmission (MT-SDT), wherein receiving the configuration of the SPS resource for downlink data reception in the inactive state is based at least in part on the indication of the UE capability for SPS reception of MT-SDT.

9. The UE of claim 1, wherein the paging DCI includes the indication that activates the SPS resource for downlink data reception in the inactive state.

10. The UE of claim 9, wherein the paging message indicates at least one UE identifier, and wherein the one or more processors are further configured to:
activate the SPS resource for downlink data reception in the inactive state based at least in part on the paging DCI including the indication that activates the SPS resource for downlink data reception in the inactive state and based at least in part on a determination that the at least one UE identifier, indicated in the paging message, includes a UE identifier of the UE.

11. The UE of claim 1, wherein the paging message includes the indication that activates the SPS resource for downlink data reception in the inactive state.

12. The UE of claim 11, wherein the paging message indicates at least one UE identifier, and wherein the one or more processors are further configured to:
activate the SPS resource for downlink data reception in the inactive state based at least in part on the paging message including the indication that activates the SPS resource for downlink data reception in the inactive state and based at least in part on a determination that the at least one UE identifier, indicated in the paging message, includes a UE identifier of the UE.

13. The UE of claim 1, wherein the paging DCI or the paging message includes an indication for triggering downlink channel state information (CSI) reporting for downlink data reception in the inactive state, and wherein the one or more processors are further configured to:
transmit, to the network node while operating in the inactive state, a CSI report based at least in part on the indication for triggering downlink CSI reporting for downlink data reception in the inactive state.

14. The UE of claim 13, wherein the one or more processors are further configured to:
receive, from the network node while operating in an RRC connected state, an RRC release message that includes at least one of a CSI report configuration or a CSI measurement configuration for downlink CSI reporting for downlink data reception in the inactive state.

15. The UE of claim 14, wherein the RRC release message includes the CSI report configuration, wherein the CSI report configuration indicates an uplink resource for CSI reporting, and wherein the one or more processors, to transmit the CSI report, are configured to:
transmit the CSI report on the uplink resource for CSI reporting.

16. The UE of claim 15, wherein the uplink resource for CSI reporting includes at least one of a physical uplink control channel (PUCCH) resource for periodic CSI reporting or a physical uplink shared channel (PUSCH) resource for aperiodic CSI reporting.

17. The UE of claim 14, wherein the RRC release message includes the CSI measurement configuration, wherein the CSI measurement configuration indicates a configuration of a resource pool including a set of reference signal resources, wherein the paging message indicates one or more candidate reference signal resources of the set of reference signal resources included in the resource pool, and wherein the one or more processors are further configured to:
perform CSI measurements on the one or more candidate reference signal resources while operating in the inactive state, wherein the CSI report is based at least in part on the CSI measurements on the one or more candidate reference signal resources.

18. The UE of claim 13, wherein the paging message indicates an uplink resource for CSI reporting, and wherein the one or more processors, to transmit the CSI report, are configured to:
transmit the CSI report on the uplink resource for CSI reporting.

19. The UE of claim 13, wherein the indication for triggering downlink CSI reporting for downlink data reception in the inactive state is included in a CSI request field of the paging DCI.

20. The UE of claim 13, wherein the indication for triggering downlink CSI reporting for downlink data reception in the inactive state is included in a medium access control (MAC) control element (MAC-CE) that is included in the paging message.

21. The UE of claim 13, wherein the indication for triggering downlink CSI reporting for downlink data reception in the inactive state is an indication, included in the paging message, of a dedicated uplink resource, and wherein the one or more processors, to transmit the CSI report, are configured to:
transmit the CSI report on the dedicated uplink resource.

22. The UE of claim 13, wherein the one or more processors, to transmit the CSI report, are configured to:
transmit the CSI report based at least in part on the paging DCI or the paging message including the indication for triggering downlink CSI reporting for MT-SDT and based at least in part on a determination that a UE identifier of the UE is indicated in the paging message.

23. A network node for wireless communication, comprising:
a memory; and
one or more processors, coupled to the memory, configured to:
transmit, to a user equipment (UE), a configuration of a semi-persistent scheduling (SPS) resource for downlink data reception in an inactive state;
transmit, to the UE while the UE is in the inactive state, paging downlink control information (DCI) and a paging message for triggering downlink data reception in the inactive state, wherein the paging DCI or the paging message includes an indication that activates the SPS resource for downlink data reception in the inactive state; and
transmit, to the UE while the UE is in the inactive state, one or more transmissions of downlink data via the SPS resource for downlink data reception in the inactive state.

24. The network node of claim 23, wherein the configuration of the SPS resource downlink data reception in the inactive state includes an SPS configuration and an indication of an SPS physical downlink shared channel (PDSCH) resource to be used for downlink data reception in the inactive state in accordance with the SPS configuration.

25. The network node of claim 23, wherein the paging DCI or the paging message includes an indication for triggering downlink channel state information (CSI) reporting for downlink data reception in the inactive state, and further comprising:
receive, from the UE while the UE is operating in the inactive state, a CSI report based at least in part on the indication for triggering downlink CSI reporting for downlink data reception in the inactive state.

26. A method of wireless communication performed by a user equipment (UE), comprising:
receiving, from a network node, a configuration of a semi-persistent scheduling (SPS) resource for downlink data reception in an inactive state;
receiving, from the network node and while operating in the inactive state, paging downlink control information (DCI) and a paging message for triggering downlink data reception in the inactive state, wherein the paging DCI or the paging message includes an indication that activates the SPS resource for downlink data reception in the inactive state; and
receiving, from the network node and while operating in the inactive state, one or more transmissions of downlink data via the SPS resource for downlink data reception in the inactive state.

27. The method of claim 26, wherein the configuration of the SPS resource downlink data reception in the inactive state includes an SPS configuration and an indication of an SPS physical downlink shared channel (PDSCH) resource to be used for downlink data reception in the inactive state in accordance with the SPS configuration.

28. The method of claim 26, wherein the paging DCI or the paging message includes an indication for triggering downlink channel state information (CSI) reporting for downlink data reception in the inactive state, and further comprising:
transmitting, to the network node while operating in the inactive state, a CSI report based at least in part on the indication for triggering downlink CSI reporting for downlink data reception in the inactive state.

29. The method of claim 28, further comprising:
receiving, from the network node while operating in an RRC connected state, an RRC release message that includes at least one of a CSI report configuration or a CSI measurement configuration for downlink CSI reporting for downlink data reception in the inactive state.

30. A method of wireless communication performed by a network node, comprising:
transmitting, to a user equipment (UE), a configuration of a semi-persistent scheduling (SPS) resource for downlink data reception in an inactive state;
transmitting, to the UE while the UE is in the inactive state, paging downlink control information (DCI) and a paging message for triggering downlink data reception in the inactive state, wherein the paging DCI or the paging message includes an indication that activates the SPS resource for downlink data reception in the inactive state; and
transmitting, to the UE while the UE is in the inactive state, one or more transmissions of downlink data via the SPS resource for downlink data reception in the inactive state.
